(19) United States
(12) Patent Application Publication
(10) Pub. No.: US 2026/0032524 A1
(43) Pub. Date: Jan. 29, 2026

(54) METHOD FOR SELECTIVE ACTIVATION OF CELL GROUPS

(71) Applicant: ZTE CORPORATION, Shenzhen (CN)

(72) Inventors: Mengjie ZHANG, Shenzhen (CN); He HUANG, Shenzhen (CN); Jing LIU, Shenzhen (CN); Fei DONG, Shenzhen (CN)

(73) Assignee: ZTE CORPORATION, Shenzhen (CN)

(21) Appl. No.: 19/348,217

(22) Filed: Oct. 2, 2025

Related U.S. Application Data
(63) Continuation of application No. PCT/CN2023/087119, filed on Apr. 7, 2023.

(51) Int. Cl. H04W 36/00; H04L 5/00; H04W 12/041; H04W 36/36

(52) U.S. Cl. CPC H04W 36/0016; H04L 5/0053; H04W 12/041; H04W 36/362

(57) ABSTRACT

This disclosure is directed generally to wireless communications and more specifically to an improved handling of mobility of wireless terminals via successive/subsequent conditional cell change. The various example implementations are provided to describe example manners for preparing candidate SCG/PSCell configurations for SCG selective activation to support subsequent conditional PSCell addition/change among various network elements, including indicating the available/subsequent candidate PSCells among all candidate PSCells to be evaluated when a candidate PSCell become a serving PSCell during the UE mobility.

### TECHNICAL FIELD

This disclosure is directed generally to wireless communications and more specifically to an improved handling of mobility of wireless terminals via successive/subsequent conditional cell change.

### BACKGROUND

Wireless communication technologies are moving the world toward an increased network connectivity. Wireless communications rely on efficient network resource management and allocation between user stations and wireless access network nodes (including but not limited to wireless base stations) in a highly mobile environment. A new generation network is expected to provide high speed, low latency and ultra-reliable communication capabilities and to fulfil the requirements from different industries and users. User mobile stations or user equipment (UE) are becoming more complex in order to handle increasing amount of data communications. In order to improve communications and meet higher reliability requirements, improvements on mobility management is critical.

### SUMMARY

This disclosure is directed generally to wireless communications and more specifically to an improved handling of mobility of wireless terminals via successive/subsequent conditional cell change. The various example implementations are provided to describe example manners for preparing candidate SCG/PSCell configurations for SCG selective activation to support subsequent conditional PSCell addition/change among various network elements, including indicating available/subsequent candidate PSCells among all candidate PSCells to be evaluated when a candidate PSCell become a serving PSCell during the UE mobility.

In some implementations, a method for selective activation of cell groups for a wireless terminal in a wireless network and performed by a master node (MN) is performed. The method may include sending a request message to a candidate secondary node (SN) to request preparation of a cell group selective activation procedure for the wireless terminal; receiving an acknowledgement message from the candidate SN in response to the request message, the acknowledgement message comprising a first list of cell identifiers for a set of candidate cells; generating a reconfiguration message based on the acknowledgement message, the reconfiguration message comprising a cell group selective activation configuration; and sending the reconfiguration message to the wireless terminal.

In the example implementation above, the acknowledgement message comprises a second list of candidate SNs or cells corresponding to one of the set of candidate cells, the second list of candidate SNs or cells comprising subsequent candidates for conditional cell change (CPC) when the one of the set of candidate cells becomes a current serving cell for the wireless terminal.

In any one of the example implementations above, the request message comprises at least one of an indication to the candidate SN that the candidate SN is allowed to suggest subsequent candidate cells for a next/subsequent CPC for the wireless terminal; a list of suggested candidate SN or cell identifiers for the next/subsequent CPC; an upper limit of a number of subsequent candidate cells that can be prepared for the next/subsequent CPC for each candidate cell; a list of SN key or an SN key range to be used for the next/subsequent CPC; or a counter value or a list of counter value to be used for SN key derivation for the next/subsequent CPC.

In any one of the example implementations above, the request message comprises an indication to the candidate SN that the candidate SN is allowed to suggest subsequent candidate cells for a next/subsequent CPC; and the request message is received by the candidate SN to trigger the SN to perform at least one of: identifying the set of candidate cell; identifying the second list of candidate SNs or cells corresponding to the one of the set of candidate cells from MN suggestions if included in the request message; and determining execution conditions for each of the second list of candidate SNs or cells based on a candidate cell measurement configuration.

In any one of the example implementations above, the selective activation of cell groups is initiated by the MN.

In any one of the example implementations above, the selective activation of cell groups is initiated by a source SN in communication with the wireless terminal. The method may further include, before sending the request message to the candidate SN, receiving an SN change required message from the source SN. The SN change required message comprises at least one of: an indication to the MN that the candidate SN is allowed to suggest subsequent candidate cells for a next/subsequent CPC for the wireless terminal; a list of suggested candidate SN or cell identifiers for the next/subsequent CPC; or an upper limit of a number of subsequent candidate cells that can be prepared for the next/subsequent CPC for each candidate cell by the candidate SN.

In any one of the example implementations above, generating a reconfiguration message may include receiving a second acknowledgement message from at least another candidate SN; and generating the reconfiguration message based on the acknowledgement message and the second acknowledgement message.

In any one of the example implementations above, the method may further include generating a report and transmitting the report to the candidate SN to inform the candidate SN a subset of the subsequent candidates for conditional cell change that are included in the reconfiguration message to the wireless terminal.

In any one of the example implementations above, the method may further include receiving from the wireless terminal a reconfiguration complete message in response to the reconfiguration message, the reconfiguration complete message comprising an information to identify a target SN selected by the wireless terminal. The method may further include sending an SN reconfiguration complete message to the target SN.

In any one of the example implementations above, the method may further include sending a report message to a source SN connected to the wireless terminal, the report message indicating to the source SN the cell group selective activation procedure for the source SN to keep a context of the wireless terminal or to discard/release a current SN key.

In any one of the example implementations above, the method may further include sending a report message to each of other candidate SNs, the report message indicating to each of the other candidate SNs to keep or release a list of candidate cells prepared for the cell group selective activation procedure or to discard/release/update a candidate SN key.

In any one of the example implementations above, the cell group selective activation configuration comprises at least one of the following: a list of prepared candidate cells; execution conditions for each of the list of prepared candidate cells; a list of prepared subsequent candidate cells for each of the list of prepared candidate cells; and execution conditions for each of the list of prepared subsequent candidate cells.

In some other example implementations, a method for selective activation of cell groups for a wireless terminal in a wireless network and performed by a candidate SN is disclosed. The method may include receiving a request message from a master node (MN) of the wireless terminal to request preparation of a cell group selective activation procedure for the wireless terminal; preparing a first list of cell identifier for a set of candidate cells; and sending an acknowledgement message to the MN, the acknowledgement message comprising the first list of cell identifiers.

In the example implementations above, the method may further include preparing a second list of candidate SNs or cells corresponding to one of the set of candidate cells, the second list of candidate SNs or cells comprising subsequent candidates for conditional cell change (CPC) when the one of the set of candidate cells becomes a current serving cell for the wireless terminal, wherein the acknowledgement message further comprises the second list of candidate SNs or cells corresponding to the one of the set of candidate cells.

In any one of the example implementations above, the request message comprises at least one of: an indication to the candidate SN that the candidate SN is allowed to suggest subsequent candidate cells for a next/subsequent conditional cell CPC for the wireless terminal; a list of suggested candidate SN or cell identifiers for the next/subsequent CPC; an upper limit of a number of subsequent candidate cells that can be prepared for the next/subsequent CPC for each candidate cell; a list of SN key or an SN key range to be used for the next/subsequent CPC; or a counter value or a list of counter value to be used for SN key derivation for the next/subsequent CPC.

In any one of the example implementations above, the method may further include receiving a report from the MN, the report informing the candidate SN a subset of the subsequent candidates for conditional cell selection that are not included in a reconfiguration message sent from the MN to the wireless terminal.

In some other implementations, a wireless communications apparatus is disclosed. The wireless communication apparatus may include a processor and a memory, wherein the processor is configured to read code from the memory and implement any one of the methods above.

In yet some other implementations, a non-transitory computer readable medium is disclosed. The non-transitory computer readable medium may include computer instructions, when executed by a processor of a wireless communication device, may cause the wireless communication device to implement any one of the methods above.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or User Equipments (UEs) and a wireless access network node in communication with one another via an over-the-air radio communication interface.

FIG. 3 shows an example radio access network (RAN) architecture.

FIG. 4 shows an example communication protocol stack in a wireless access network node or wireless terminal device including various network layers.

FIG. 5 illustrates basic scenario for SN change.

FIG. 6 illustrates secondary cell group candidates for subsequent conditional PSCell addition/change.

FIG. 7 shows an example data and logic flow among various network elements for selective secondary cell group activation.

FIG. 8 shows another example data and logic flow among various network elements for selective secondary cell group activation.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

### Wireless Network Overview

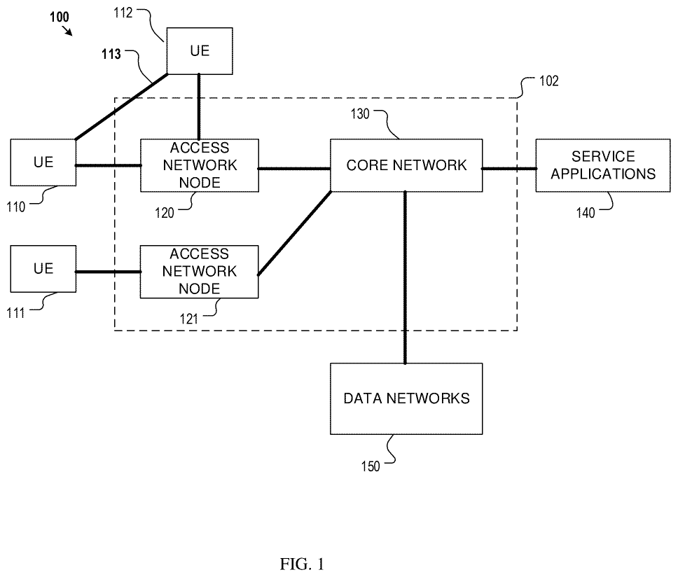

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

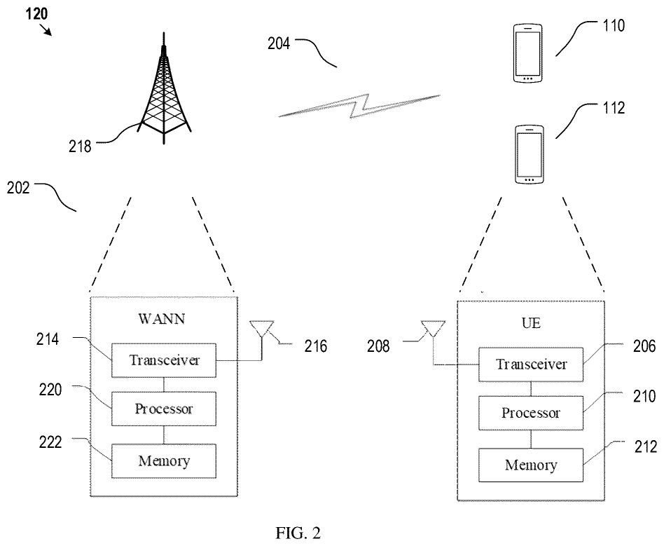

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

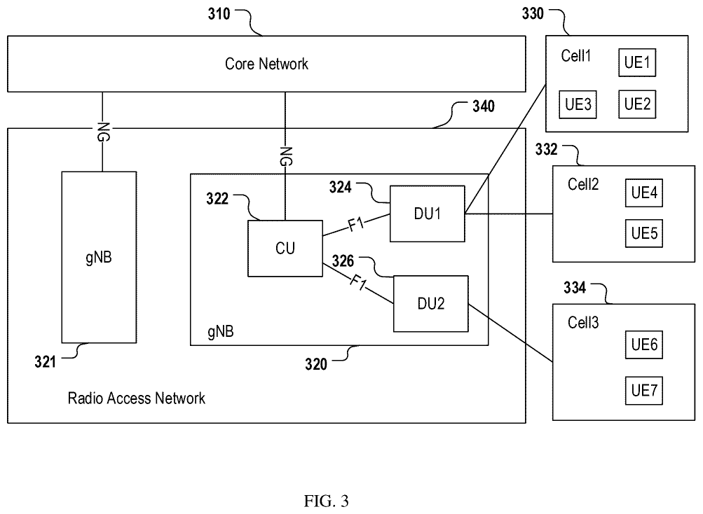

Returning to wireless radio access network (RAN), FIG. 3 illustrates an example RAN 340 in communication with a core network 310 and wireless terminals UE1 to UE7. The RAN 340 may include one or more various types of wireless base station or WANNs 320 and 321 which may include but are not limited to gNB, eNodeB, NodeB, or other type of base stations. The RAN 340 may be backhauled to the core network 310. The WANNs 320, for example, may further include multiple separate access network nodes in the form of a Central Unit (CU) 322 and one or more Distributed Unit (DU) 324 and 326. The CU 322 is connected with DU1 324 and DU2 326 via various interfaces, for example, an F1 interface. The F1 interface, for example, may further include an F1-C interface and an F1-U interface, which may be used to carry control plane information and user plane data, respectively. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

The UEs may be connected to the network via the WANNs 320 over an air interface. The UEs may be served by at least one cell. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 1, UE1, UE2, and UE3 may be served by cell 1 330 of the DU1, whereas UE4 and UE5 may be served by cell2 332 of the DU1, and UE6 and UE7 may be served by cell3 associated with DU2. In some implementations, a UE may be served simultaneously by two or more cells. Each of the UE may be mobile and the signal strength and quality from the various cells at the UE may depend on the UE location and mobility.

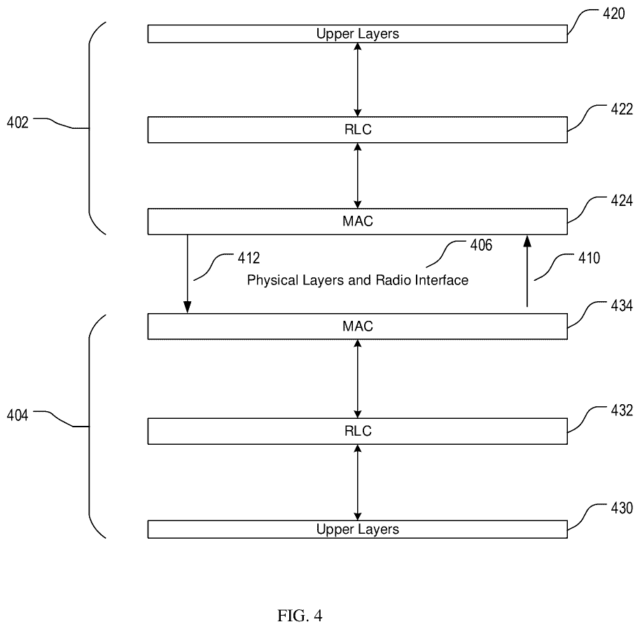

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. In some situations, the term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, service data adaptation protocol (SDAP) layers and/or PDCP layers/entities.

### Conditional PSCell Addition/Change (CPAC)

UE in the wireless network may be configured to operate in Dual Connectivity, including intra-E-UTRA DC or Multi-Radio DC (MR-DC). In dual connectivity, the UE may be served by a master node (MN) and a secondary node (SN). The MN and the SN may be based the same or different radio access technologies (RAT). For example, in case of intra-E-UTRA DC, both the MN and SN provide E-UTRA access. While in case of MR-DC, one node provides NR access and the other one provides either E-UTRA or NR access.

One or multiple serving cells can be configured both on MN and SN. Serving cells configured on MN are defined as a Master Cell Group (MCG) while serving cells configured on SN are defined as a Secondary Cell Group (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as spCell (special Cell). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

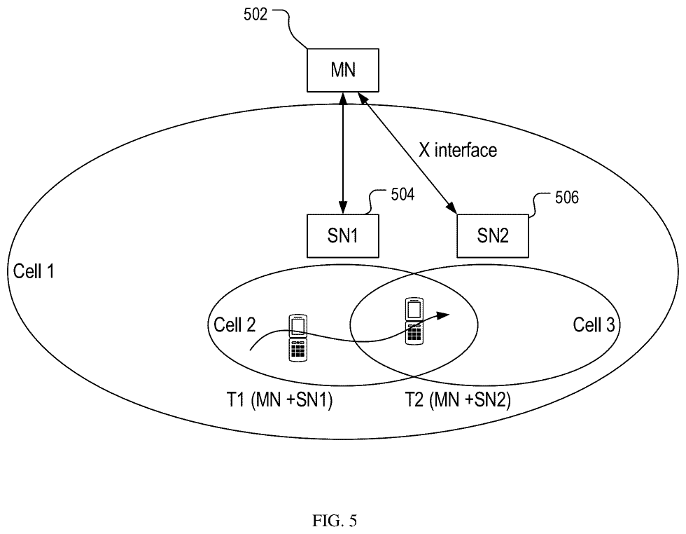

FIG. 5 illustrates one possible scenario of SN change. FIG. 5 shows three example network nodes (e.g., Base Station) including MN (502), SN1 (504) and SN2 (506). Cell1, Cell2 and Cell3 are example corresponding cells generated by MN, SN1 and SN2 respectively. Cell 2 and Cell 3 are special cell of the secondary cell group (SCG), defined as primary SCG cell (PSCell). X interfaces are deployed between MN and SN1/SN2. At a time T1, UE may be operating in DC between MN and SN1. With the movement of the UE, at time T2, the SN for the UE may switch from SN1 to SN2. Such an SN Change can be initiated either by the MN or the source SN (e.g., SN1).

In some situations, such 5G network with small cells, cell switch or SN change could be very frequent. To reduce interruption time and improve mobility reliability (i.e., mobility robustness), Conditional PSCell Addition/Change (CPAC) may be implemented. CPAC is defined as a PSCell addition/change that is executed by the UE when execution condition(s) is met. The UE starts evaluating the execution condition(s) upon receiving a CPAC configuration, and stops evaluating the execution condition(s) once the PSCell addition/change is triggered. The CPAC configuration, for example, may include candidate PSCell configuration (including SCG configuration generated by candidate SN(s) and possibly MCG configuration generated by the MN) and corresponding execution condition(s) for the candidate PSCell.

The CPAC procedure can be triggered by either the MN or the SN, so it can be categorized as MN initiated CPAC or SN initiated CPAC. In addition, the CPAC procedure can be involved with MN or without MN, so it can be classified as CPAC with MN involvement or CPAC without MN involvement (i.e., intra-SN CPC (Conditional PSCell Change) without MN involvement) as well.

For MN initiated CPA/CPC, the execution condition may be generated by the MN, e.g. Event A4, based on MCG MeasConfig. For SN initiated CPC, the execution condition may be generated by the source SN, e.g. Event A3/A5, based on SCG MeasConfig. Events A3, A4, and A5 may be defined as the following occurrence:
Event A3: Neighbor's measurement signal becomes better than PCell/PSCell by an amount of offset;
Event A4: Neighbor's measurement signal becomes better than an absolute threshold;
Event A5: PCell/PSCell becomes worse than one absolute threshold 1 AND Neighbor/SCell becomes better than another absolute threshold 2.

### Selective Activation of Cell Group (CG)

For selective activation of CG change, the NW can pre-configure multiple candidate CG configurations and send the candidate CG configurations to the UE. The UE stores multiple candidate CG configurations. And the UE can perform CG change among candidate CGs based on the NW indication/signaling (e.g. RRC message, MAC CE) or the pre-configured execution conditions.

For simplicity, in the disclosure hereinafter, the term “candidate cell” may be alternatively referred to as “candidate cell group (CG).” The CG may be used to represent either one or both of MCG or SCG. The term candidate cell may be used to referred to candidate PCell in MCG, or candidate PSCell in SCG.

For MCG/PCell change, the term “selective activation of CG change” may be referred to as subsequent/successive Conditional Handover (CHO), or selective activation of MCG/PCell, MCG/PCell selective activation, conditional selective MCG/PCell, and the like. Likewise, for SCG/PSCell change, the term “selective activation of CG change” may be referred to as subsequent/successive Conditional PScell Change (CPC), subsequent/successive Conditional PScell Addition (CPA), selective activation of SCG/PSCell, SCG/PSCell selective activation, conditional selective SCG/PSCell, and the like.

In some of the implementations disclosed below, SCG/PSCell change (e.g., CPC) may be described as examples. The underlying principles and related solutions are applicable to MCG/PCell change as well.

An example baseline procedure to support subsequent PSCell/SCG change is shown below:
The NW sends multiple candidate PSCell/SCG configurations and the execution conditions of candidate PSCell/SCG to the UE.
The UE stores multiple candidate PSCell/SCG configurations and evaluates the execution conditions of candidate PSCell/SCG. When the execution condition of a candidate PSCell/SCG is met, a UE performs an execution of CPA or CPC towards this candidate PSCell.
After finishing the PSCell addition or change, the UE may not release the conditional configuration of other candidate PSCells for subsequent CPC, and continues evaluating the execution conditions of other candidate PSCells.
When the execution condition of a candidate PSCell is met, the UE may then perform the execution of subsequent CPC towards this candidate PSCell.

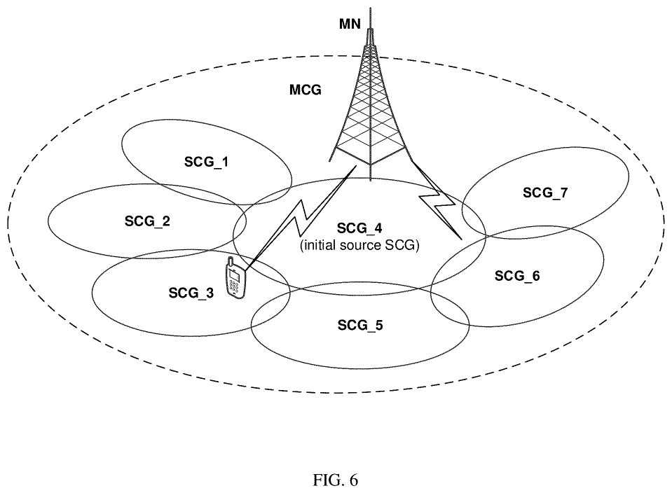

In order to support the subsequent CPAC, the candidate SCG/PSCell configurations need be maintained after one SCG/PSCell addition or change (e.g. CPA/CPC or normal conditional PSCell addition/change). When UE moves to one specific candidate SCG/PSCell, some other candidate SCGs/PSCells may be not suitable as candidates for the next SCG/PSCell change (e.g. next CPC execution). For example, as shown in FIG. 6, there may be 7 candidate SCGs pre-configured by the NW for subsequent CPAC. When the UE moves to SCG_3, neighboring SCG_2, SCG_4, SCG_5 could be the candidate SCGs for the next SCG change. But other SCGs such as SCG_1, SCG_6, SCG_7 may not be suitable for the next CG change. Thus, the NW may further indicate for each candidate SCG, which candidate SCGs are available for the subsequent SCG change. The UE just needs to perform the evaluation on execution conditions for these available candidate SCGs when moving to a specific SCG, to avoid unnecessarily evaluating other candidates and also avoid frequent candidate updates via RRCReconfigurtaion (e.g., to release some candidates and re-add them again). In other words, the UE can maintain configuration of all the candidate SCGs/PSCells, but only need to monitor and evaluate a subset of SCGs/PSCells for the subsequent SCG/PSCell change. The subset of SCGs/PSCells are indicated by the NW.

The various example implementations are provided to describe example manners to prepare candidate SCG/PSCell configurations for SCG selective activation (i.e. to support subsequent CPAC) among various network elements, including indicating the available/subsequent candidate PSCells among all candidate PSCells to be evaluated when a candidate PSCell become a serving PSCell during the UE mobility.

### Example Procedure and Signaling for SCG Selective Activation

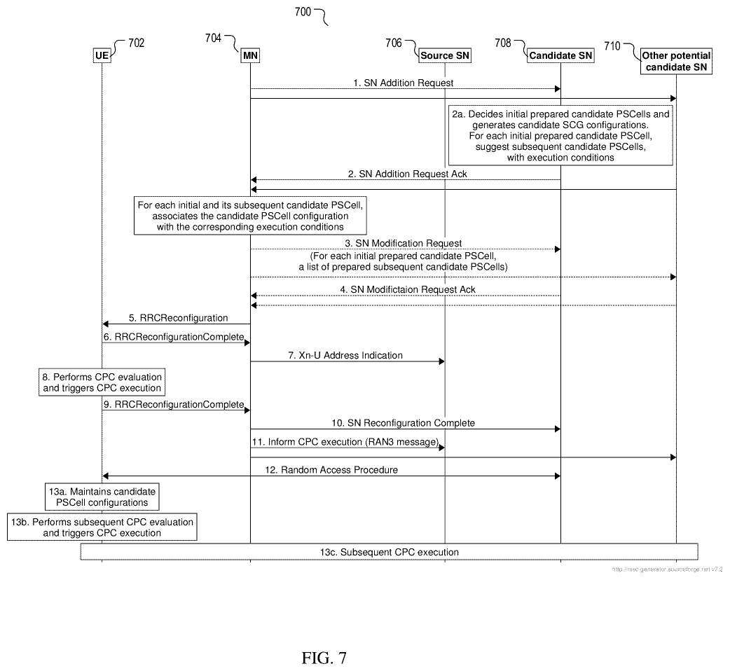

FIG. 7 shows an example data and logic flow 700 for SCG selective activation. The SCG selective activation may be initiated by the MN. The example data and logic flow of FIG. 7 may include the following information exchange between the UE 702, the MN 704, the source SN 706, candidate SNs 708 and 710:
Step 1: The MN sends an SN Addition Request message to a set of candidate SNs, e.g., the candidate SN 708 and another candidate SN 710 (only one of these candidates is tracked below) to request a preparation/initiation of SCG selective activation procedure. The message may include at least one of the following information:
   an upper limit for a number of PSCells (candidate PSCells) that can be prepared by the candidate SN;
   measurements results related to the candidate SN;
   a list of proposed PSCell candidates suggested from the source SN, e.g. for SN initiated inter-SN SCG selective activation;
   a reference SCG configuration (so that the candidate SN only need to send differential/delta configuration of the various candidate SCG configurations);
   an indication to indicate that the request is for selective activation;
   an indication to indicate that the candidate SN/PSCell can suggest subsequent candidate PSCells for the next/subsequent CPC;
   a list of subsequent candidate SN IDs suggested for the next/subsequent CPC;
   a list of subsequent candidate PSCells suggested for the next/subsequent CPC;
   for each prepared candidate PSCell by the candidate SN, the upper limit for the number of PSCells that can be prepared for the next/subsequent CPC;
   a list of SN key or an SN key range to be used for the next/subsequent CPC;
   a counter value or a list of counter value to be used for the SN key derivation for the next/subsequent CPC;
Step 2a: From the measurement results indicated by the MN or/and the list of PSCells suggested by the MN or/and the source SN, the candidate SN decides the list of PSCell(s) to prepare (i.e. initial prepared candidate PSCells), and provides the candidate PSCell/SCG configuration for each prepared candidate PSCell (e.g. based on the reference SCG configuration as, e.g., a differential/delta candidate PSCell configuration). If an indication that indicates that the request is for selective activation or an indication indicating that the candidate SN/PSCell can suggest/select subsequent candidate PSCells for the next/subsequent CPC is received, for each initial prepared candidate PSCell, the candidate SN decides/suggests/selects subsequent candidate SNs or/and subsequent candidate PSCells for that prepared candidate PSCell. If a list of subsequent candidate SN IDs or/and subsequent candidate PSCells suggested for the next/subsequent CPC are provided by the MN, the candidate SN selects subsequent candidate SNs or/and PSCells from the list provided by the MN. The candidate SN may also provide execution conditions (e.g., events A3/A5 based execution conditions) for each subsequent candidate PSCells for the next/subsequent CPC. The execution condition may be based on the candidate SCG measurement configuration for the prepared candidate PSCell.
Step 2: The candidate SN sends an SN Addition Request Acknowledge message to the MN. The message may include a list of prepared candidate PSCell IDs, and may also include at least one of the following information for each prepared candidate PSCell:
   the candidate PSCell/SCG configuration;
   a list of suggested subsequent candidate SNs or/and PSCells for the next/subsequent CPC, e.g., a list of subsequent candidate PSCell ID (e.g. CGI);
   the execution conditions for each suggested subsequent candidate PSCells for the next/subsequent CPC;
Step 3: For each prepared candidate PSCell, if it has subsequent candidate PSCells, the MN can check whether there is a prepared candidate PSCell configuration for the subsequent candidate PSCell (whose configuration may be generated by other candidate SNs). If there is a prepared candidate PSCell configuration, the MN generates the association between the candidate PSCell configuration and the execution conditions for the subsequent candidate PSCell. If there is no prepared candidate PSCell configuration for the subsequent candidate PSCell, the MN may initiate SN addition procedure to a candidate SN that candidate PSCell belongs to, to request that SN to provide the candidate PSCell/SCG configuration for that PSCell. If there is a subsequent candidate PSCell whose candidate PSCell configuration or/and the execution condition are not prepared, the MN may inform the candidate SN. For example, for each prepared candidate PSCell, the MN may inform the candidate SN which subsequent candidate PSCells have been prepared (e.g., the cell whose candidate configuration and associated execution condition have been prepared) via an Xn/X2 message, e.g., an SN Modification Request message. The message may include a list of initial prepared candidate PSCells. For each initial prepared candidate PSCell, there may be a list of subsequent candidate SNs or/and candidate PSCells who have been prepared for the subsequent/next CPC.
Step 4: If requested (e.g., in response to the Xn/X2 message in Step 3 above), the candidate SN may send a response message to the MN, e.g. an SN Modification Request message.

In some example implementations, Step 4 above and Step 5 below may also be performed between the MN and the source SN, e.g. when the source SN is considered as a candidate SN.
Step 5: The MN generates an RRC reconfiguration message, which includes the SCG selective activation configuration. The SCG selective activation configuration may include one or multiple reference configuration, and a list of prepared candidate PSCells. For each prepared candidate PSCell, it may include the candidate PSCell ID (e.g., the candidate PSCell configuration index, PCI+frequency), the candidate PSCell/SCG configuration, execution condition(s), a list of sk-counter or SN key or/and the information for the next/subsequent CPC. For the prepared candidate PSCell, the information for the next/subsequent CPC may include a list of subsequent candidate PSCells to be evaluated when the prepared candidate PSCell becomes a serving PSCell (i.e., after PSCell addition or change to the prepared candidate PSCell) or/and the execution condition(s) for each subsequent candidate PSCell. The MN sends the generated RRC reconfiguration message to the UE.
Step 6: The UE responds with an RRC reconfiguration complete message to the MN.
Step 7: The MN may inform the source SN that the SCG selective activation procedure is configured/prepared, via an Xn/X2 message, e.g. an Xn-U Address indication message. If applicable, the source SN may start early data forwarding.
Step 8: The UE starts evaluating the execution conditions. If the execution condition(s) for one candidate PSCell is met, the UE performs CPAC procedure to the target PSCell. For example, the CPAC procedure may include applying the candidate cell configuration of that PSCell, and performing random access to that PSCell.
Step 9: The UE sends an RRCReconfigurationComplete message to the MN. The message may include information for enabling the MN to identify the SN of the selected candidate PSCell
Step 10: The MN sends SN Reconfiguration Complete message to the target SN. If there is an SN key list, the target SN uses the first SN key in the list for the subsequent data transmission with the UE.
Step 11a/b: The MN sends an Xn/X2 message (e.g., an SN Release Request message, an Xn-U Address Indication message, or other message) to inform the source SN or/and candidate SN(s) about the CPC or CPA execution. The message may include an indication that the procedure is for SCG selective activation. When receiving the message, the SN may stop providing user data to the UE, or/and to trigger late data forwarding procedure, if applicable. If the source SN is configured/considered as a candidate SN, the MN may indicate to the source SN that the UE context in SN is maintained, e.g., via an indication for SCG selective activation or an indication for UE context keep in the message. If the indication is included, the SN may keep the UE context. The source SN may discard/release/update the SN key which has been used. When receiving the message, the source SN or/and candidate SNs may update the SN key which could be used when the UE switches back to the same SN. The message to the source or candidate SN may indicate that SN to release or keep the candidate PSCells or a list of candidate PSCells prepared for the SCG selective activation. The source SN or/and candidate SNs may send a response message (e.g., an SN Release Request Acknowledge message) to the MN.
Step 12: The UE may synchronize to the selected target PSCell by, for example, performing random access.
Step 13a˜c: The UE may maintain candidate PSCell configurations and performs evaluation of execution conditions on the maintained candidate PSCells or the candidate PSCells that are indicated to perform execution condition evaluation for the next CPC (if indicated by the NW). If the execution condition for one candidate PSCell is met, the UE performs subsequent CPC execution to the selected target PSCell.

In some example implementations, e.g. before Step 1, the MN may send a request message (e.g. SN addition or modification request message) to the source SN or the candidate SN to request that the SN provides the reference SCG configuration, e.g. include an indication for the reference configuration request. In response to receiving the message or the request indication, the source or candidate SN generates the reference SCG configuration and sends it to the MN, e.g. via SN addition or modification request message acknowledge message. The reference SCG configuration may be an RRC reconfiguration message generated by the SN.

In some example implementations, the MN may send the candidate PSCell configuration index for each initial prepared candidate PSCell to the candidate SN. The candidate SN may associate the candidate PSCell configuration index and the corresponding execution conditions for the subsequent candidate PSCell. In this case, a subsequent candidate PSCell list may be included in the candidate PSCell configuration for each initial prepared candidate PSCell.

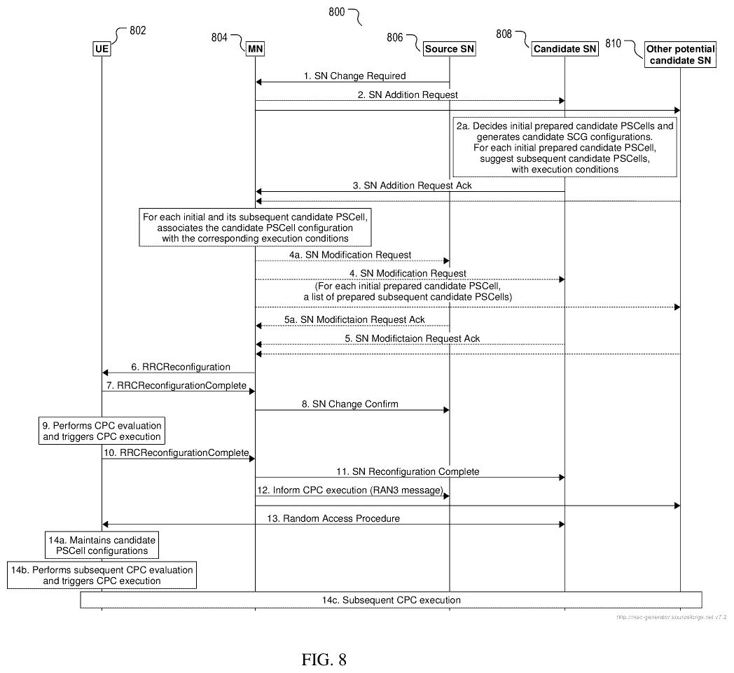

FIG. 8 shows another example data and logic flow 800 for SCG selective activation. The SCG selective activation may be initiated by the source SN rather than the MN. The example data and logic flow of FIG. 8 may include the following information exchange between the UE 802, the MN 804, the source SN 806, candidate SNs 808 and 810:
Step 1: The source SN initiates the SCG selective activation procedure by sending an SN change required message to the MN. The message may include at least one of the following information:
   a list of candidate SN IDs suggested by the source SN;
   the measurements results related to the candidate SN;
   a list of proposed PSCell candidates recommended by the source SN;
   the execution condition for each proposed PSCell candidate;
   the upper limit for the number of PSCells that can be prepared by each candidate SN;
   the reference SCG configuration generated by the source SN;
   an indication to indicate that the request is for selective activation;
   an indication to indicate whether a candidate SN/PSCell can suggest the subsequent candidate PSCells for the next/subsequent CPC;
   for each prepared candidate PSCell by a candidate SN, the upper limit for a number of PSCells that can be prepared for the next/subsequent CPC;
Step 2˜7 of FIG. 8 are similar to Step 1˜6 in FIG. 7.
Step 8: The MN may send a SN Change Confirm message to the source SN to indicate to the source SN that the SCG selective activation procedure is configured/prepared.
Step 9˜14c of FIG. 8 are similar to Step 8˜13c in FIG. 7.

In some example implementations, the SCG selective activation configuration may include at least one of the followings:
One or multiple reference configurations. The reference configuration may contain a RRCReconfigurtaion message. The reference configuration may include an MCG reference configuration or/and an SCG reference configuration;
A list of candidate PSCell/SCG configuration, which may include at least one of:
   a candidate PSCell ID, e.g. candidate configuration index, PCI+frequency;
   candidate PSCell configuration;
   the execution condition for the associated candidate PSCell. The execution condition may be used for CPA and MN initiated CPC;
   a list of sk-counter or SN key to be used for the candidate PSCell; or
   a reference configuration ID, to indicate the reference configuration used for the candidate PSCell;
A list of candidate PSCell information to be used when the indicated candidate PSCell is the current serving PSCell. The information may include at least one of:
   a serving/source PSCell ID: the ID can indicate the candidate PSCell ID in the above list, e.g. candidate configuration index, PCI+frequency. When UE's current serving PSCell ID matches with this PSCell ID, the UE uses the information in the associated/following list (i.e. a list of candidate PSCells to be evaluated) for the next CPC evaluation and execution;
   a list of candidate PSCells to be evaluated, which may include at least one of:
      a Candidate PSCell ID, e.g. candidate configuration index, PCI+frequency, to indicate the candidate PSCell to be evaluated, and the associated candidate PSCell configuration from the candidate PSCell/SCG configuration list;
      the execution condition for the associated candidate PSCell.

In some example implementations, a list of candidate PSCells to be evaluated may be included in the candidate PSCell configuration.

An example of the signaling structure for SCG selective activation configuration is shown as follows:
CandidatePSCellConfigList—a list of candidate PSCell configuration
   CandidateConfigId—the candidate PSCell configuration ID
   CandidatePSCellConfig (including RRCReconfiguration message)—candidate PSCell configuration
   CondExecutionCondition—the execution condition for the associated candidate PSCell
   Sk-counterList—a list of sk-counter to be used for the candidate PSCell
   ReferenceConfigId
CandidatePSCellList—a list of candidate PSCell info
   Source/serving PSCell ID (the ID can be PCI+frequency, or candidate PSCell configuration ID, e.g. CandidateConfigId)—when the current serving PSCell ID matches with this PSCell ID, the UE uses the information in the associated CandidateToEvaluationList for the CPC evaluation and execution.
   CandidateToEvaluationList—a list of candidate PSCells to be evaluated when the current serving PSCell becomes the PSCell indicated in the Candidate PSCell ID
      CandidateConfigId—to indicate the candidate PSCell to be evaluated, and the associated candidate PSCell configuration from the CandidatePSCellConfigList
      CondExecutionCondition—the execution condition for the associated candidate PSCell.

The second list above for candidate PScell information contains a second level list of candidate PSCell as described above. In some example embodiments, the list of candidate PSCell/SCG configuration and the list of candidate PSCell information can be combined into one list. For example, the Candidate PSCell ID may be indicated by the candidate PSCell configuration ID.

### Handling Candidate PSCell/SCG Configurations

At SCG release or SCG deactivation/activation, the NW can explicitly indicate as to how to handle the stored candidate PSCell/SCG configurations, e.g. whether to maintain such candidate PSCell/SCG configurations and/or which candidate PSCell/SCG configurations are to be maintained (e.g., in case they are needed for subsequent PSCell change/selection).

For example, if the candidate PSCell/SCG configurations are maintained after SCG release, the maintained candidate PSCell/SCG configurations may be reused for the subsequent CPA. In this case, the maintained candidate PSCell/SCG, for example, may be configured with A4 events (as described above) as execution conditions. For example, such execution conditions can be provided by the following alternatives:
Alt. 1: the execution conditions are provided/updated via RRCReconfiguration message indicating the SCG release.
Alt. 2: the execution conditions based on A4 events may be pre-configured with candidate PSCell/SCG configurations. For example, for each candidate PSCell/SCG, it may be associated with at least two set of execution conditions:
   One set is based on A4 events, generated by the MN, used for CPA or MN initiated CPC.
   The other set is based on A3/A5 events (which may be generated by the MN, source SN or candidate SN) used for CPC.

In some example implementations, for inter-MN PCell change, the CPA/CPC configurations may be released by the NW by an explicit indication.

In some example implementations, if the indication is sent from the source MN, a separate RRCReconfiguration message may be required before sending the HO command to the UE.

In some example implementations, if the indication is sent from the target MN, the source MN may need to inform the target MN that CPA/CPC was configured to the UE or/and the configured candidate PSCell/SCG list via HO request message. Then the target MN can include an release indication in the HO command (i.e. RRCReconfiguration message) to release the CPA/CPC configuration or to indicate which candidate PSCells to be released or maintained, or the target MN can send an release indication via RRCReconfiguration message after the UE successfully completes the random access to the target PCell.

### Conditional Handover (CHO) With Multiple Candidate SCGs

For CHO with candidate SCGs, the network provides candidate PCell configuration with candidate PSCell configuration (e.g. CHO configuration including MCG and SCG configuration), and execution conditions for candidate PCell and candidate PSCells. Upon receiving the candidate configurations, the UE performs evaluation on candidate PCells and candidate PSCells simultaneously. When execution conditions for candidate PCell and candidate PSCell are met simultaneously, the UE performs CHO with SCG procedure to access the target PCell and target PSCell.

In some example implementations, the CHO preparation procedure with candidate SCGs is initiated by the source MN. The procedure may include at least one of the following steps:
Step 1: The source MN sends a Handover request message to the candidate MN. The message may include the requested candidate PCell ID, an indication to indicate that the request is for CHO with candidate SCGs, or/and an indication to request the candidate MN to generate the execution conditions for the prepared candidate PSCell.
Step 2: The candidate MN decides the candidate SN(s) for the requested candidate PCell, and sends an SN addition request message to each candidate SN to request the candidate SN to prepare candidate PSCell. If the candidate SN is the same node as the source SN, the candidate MN may indicate to the SN to generate/provide the execution condition for the prepared candidate PSCells. The execution condition is generated based on the source SCG measurement configuration.
Step 3: The candidate SN replies the SN addition request acknowledge message to the candidate MN. The message may include the prepared candidate PSCell ID, the candidate PSCell/SCG configuration, the execution condition, or/and the updated source SCG measurement configuration (if the candidate SN is the same node as the source SN).
Step 4: The candidate MN generates candidate configuration for PCell and PSCell (i.e., the MN RRC reconfiguration message with both MCG and SCG configuration). The candidate MN may generate the execution condition for the prepared candidate PSCell (e.g., event A4 threshold). The candidate MN then sends a handover request acknowledge message to the source MN. The message may include at least one of the following:
   The candidate configuration for PCell and PSCell;
   The associated candidate PSCell ID(s) for the candidate PCell;
   The execution conditions generated by the candidate MN;
   The execution conditions generated by the candidate SN, if the candidate SN is the same node as the source SN;
   The updated source SCG measurement configuration (if the candidate SN is the same node as the source SN); or
   An indication to indicate/request the source SN or the source MN to generate the execution conditions for the prepared candidate PSCell.
Step 5: If the execution conditions for candidate PSCell generated by the MN is received, the source MN may generate/translate the execution conditions based on the source MCG MeasConfig to the UE according to the received information from the candidate MN. For example, the source MN configures the CondEvent A4 associated with the candidate PSCell frequency in source MCG MeasConfig, using the threshold value set by the candidate MN. If an indication to indicate/request the source MN to generate the execution conditions for the prepared candidate PSCell is received or no execution conditions for prepared candidate PSCell is received, the source MN generates the execution conditions based on the source MCG MeasConfig for the candidate PSCell. If an indication to indicate/request the source SN to generate the execution conditions for the prepared candidate PSCell is received, the source MN sends an SN request message (e.g., SN modification request message) to the source SN, to request the source SN to generate the execution conditions. The request message may include the prepared candidate PSCell ID(s) and/or an indication for the execution condition generation. The source SN generates the execution conditions based on the source SCG MeasConfig, and respond with an SN request acknowledge (e.g., SN modification request acknowledge message) to the source MN, including the generated execution conditions for the prepared candidate PSCell(s), and/or updated source SCG measurement configuration.
Step 6: The source MN generates the RRCReconfiguration message including the CHO with candidate SCG configurations and sends the message to the UE. The CHO with candidate SCG configurations includes candidate configuration for candidate PSCell and PSCell, and associated execution conditions for candidate PSCell and PSCell.

### Handling Reference Configuration and Candidate Configuration

The network can pre-configure multiple candidate cell configurations for mobility, e.g., L1/L2 triggered mobility (LTM), CHO, CPAC, selective activation of cell groups, etc. A reference configuration can be provided by the network, as the baseline of the candidate cell configuration, to reduce the signaling overhead.

The LTM is a procedure in which a gNB receives L1 measurement reports from UEs, and based on the reports, the gNB changes UEs' serving cell(s) by a cell switch command through a L1 or L2 signaling (e.g. DCI or MAC CE), which indicates an LTM candidate cell configuration that the gNB previously prepared and provided to the UE through RRC signaling. Then cell switch is triggered, by selecting the indicated LTM candidate cell configuration as the target configuration by the gNB.

In some example implementations, a separate reference configuration may be explicitly provided by the network. Upon receiving the reference configuration, the UE stores it separately.

In some example implementations, a separate reference configuration is not provided by the network, i.e., there is no separate reference configuration. The network indicates a candidate cell configuration as a reference configuration. Upon receiving the indication, the UE stores the indicated candidate cell configuration as a reference configuration separately.

In some example implementations, a separate reference configuration is not provided by the network, i.e., there is no separate reference configuration. The network provides the candidate cell configuration as a candidate delta configuration based on the current UE configuration (used when receiving this candidate configuration) or a candidate full configuration.

In some example implementations, the UE performs at least one of the following operations to handle the candidate cell configuration:
If there is no separate reference configuration, the candidate delta configuration is applied on top of the current UE configuration (used when receiving this candidate configuration) to form a complete candidate configuration.
If there is a separate reference configuration, the candidate delta configuration is applied on top of the reference configuration to form a complete candidate configuration.
It is up to UE implementation when to form the complete candidate configuration, e.g., either at the time when receiving the candidate cell configuration or upon triggering the mobility execution (e.g., upon reception of LTM switch command in case of LTM, upon the execution condition for the candidate cell is met in case of CHO/CPAC/SCG selective activation, etc.).
Upon forming the complete candidate configuration, the UE stores the generated candidate cell configuration for subsequent mobility.
The complete candidate configuration is applied and replacing the current UE configuration (at the time of reconfiguration execution/cell switch), by an RRC reconfiguration procedure that makes replacements of configuration. For LTM, the replacement procedure may not necessarily reset MAC, RLC or PDCP.

When forming the complete candidate configuration:
For Need R IEs, only if the parameters are included in the candidate delta configuration, the UE shall include them in the complete candidate configuration.
For Need N IEs, if the parameters are included in the ToAddModList in the reference configuration and not included in the ToReleaseList in the candidate delta configuration, or if the parameters are included in the ToAddModList in the candidate delta configuration, the UE shall include them in the ToAddModList in the complete candidate configuration, i.e. there is no ToReleaseList in the complete candidate configuration.
For Need M IEs, if the parameters are included in the reference configuration or the candidate delta configuration, the UE shall include them in the complete candidate configuration.

When applying the complete candidate configuration and replacing the current UE configuration, the UE may perform at least one of the following:
firstly clear/release the all current dedicated radio configurations except for some specific fields (e.g., RLC bearers, radio bearers) but maintain the current MAC, RLC and PDCP entities, e.g., store states variables and the data stored in transmission and reception buffers;
apply the fields in the complete candidate configuration, according to the operation defined in section 5.3.5.3;
determine if to reset MAC/RLC/PDCP or not based on RRC configuration (e.g., set of cells) for the target candidate cell, e.g., for LTM, if the candidate cell and the source cell belong to the same cell set, the MAC/RLC/PDCP reset may be not required; or
Upon applying the fields in the complete candidate configuration, release RLC bearers/radio bearers if they are not included in the ToAddModList in the complete candidate configuration.

In some example implementations, the UE performs the compliance check on the reference configuration upon receiving the reference configuration. If the UE detects compliance check failure on the reference configuration, the UE may report the compliance check failure to the network via UL message, e.g., RRCReconfigurationComplete message. The UE may also discard the reference configuration.

In some example implementations, it is up to UE implementation when to perform compliance check for the candidate cell configuration, e.g., upon forming the complete candidate configuration, reception the candidate cell configuration, or triggering the mobility execution.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for selective activation of cell groups, performed by a master node (MN), comprising:
sending a request message to a candidate secondary node (SN) to request a preparation of a cell group selective activation procedure for a wireless terminal;
receiving an acknowledgement message from the candidate SN in response to the request message, the acknowledgement message comprising a first list of cell identifiers for a set of candidate cells; and
sending a reconfiguration message to the wireless terminal, the reconfiguration message comprising a cell group selective activation configuration,
wherein the cell group selective activation procedure comprises a subsequent conditional PSCell addition/change (CPAC) procedure, and wherein cell group selective activation configuration comprises a subsequent CPAC configuration.

2. The method of claim 1, wherein the acknowledgement message comprises, for each of the set of candidate cells, at least one of: a cell identifier, a candidate PSCell or Secondary Cell Group (SCG) configuration, a list of suggested subsequent candidate PSCells for a subsequent conditional cell change (CPC); or execution conditions for each of the suggested subsequent candidate PSCells.

3. The method of claim 1, wherein the request message comprises at least one of:
a list of suggested candidate SN or cell identifiers for a subsequent CPC;
a list of SN key to be used for the subsequent CPC; or
a list of counter values to be used for SN key derivation for the subsequent CPC.

4. The method of claim 2, wherein:
the request message comprises an indication to the candidate SN that the candidate SN is allowed to suggest subsequent candidate cells for the subsequent CPC; and
the request message is received by the candidate SN to trigger the SN to perform at least one of:
identifying the set of candidate cell;
identifying the list of suggested subsequent candidate PSCells corresponding to the each of the set of candidate cells from MN suggestions if included in the request message; and
determining execution conditions for each of the list of suggested subsequent candidate PSCells.

5. The method of claim 1, wherein the subsequent CPAC procedure is initiated by the MN.

6. The method of claim 1, wherein the subsequent CPAC procedure is initiated by a source SN in communication with the wireless terminal.

7. The method of claim 6, further comprising, before sending the request message to the candidate SN, receiving an SN change required message from the source SN.

8. The method of claim 7, wherein the SN change required message comprises at least one of:
an indication to the MN that the required SN change is for the cell group selective activation procedure;
a list of suggested candidate SN or cell identifiers for a the next/subsequent CPC; or
a reference SCG configuration.

9. The method of claim 1, wherein sending the reconfiguration message comprises:
receiving a second acknowledgement message from at least another candidate SN; and
sending the reconfiguration message, the reconfiguration message being based on the acknowledgement message and the second acknowledgement message.

10. The method of claim 2, further comprising transmitting a report to the candidate SN to inform the candidate SN a subset of the list of suggested subsequent candidate PSCells for the subsequent CPC, the subset of the list of suggested subsequent candidate PSCells being included in the reconfiguration message to the wireless terminal.

11. The method of claim 1, further comprising receiving from the wireless terminal a reconfiguration complete message, the reconfiguration complete message comprising an information to identify a target SN selected by the wireless terminal.

12. The method of claim 11, further comprising sending an SN reconfiguration complete message to the target SN.

13. The method of claim 11, further comprising sending a report message to a source SN connected to the wireless terminal, the report message indicating to the source SN to keep or release a context of the wireless terminal or to discard/release/update a current SN key.

14. The method of claim 12, further comprising sending a report message to each of other candidate SNs, the report message indicating to each of the other candidate SNs to keep or release a list of candidate cells prepared for the cell group selective activation procedure or to discard/release/update a candidate SN key.

15. The method of claim 1, wherein the subsequent CPAC configuration comprises at least one of:
a list of prepared candidate cells;
execution conditions for each of the list of prepared candidate cells;
a list of prepared subsequent candidate cells for each of the list of prepared candidate cells; and
execution conditions for each of the list of prepared subsequent candidate cells.

16. A method for selective activation of cell groups, performed by a candidate secondary node (SN), comprising:
receiving a request message from a master node (MN) of a wireless terminal to request a preparation of a cell group selective activation procedure for the wireless terminal;
preparing a first list of cell identifier for a set of candidate cells; and
sending an acknowledgement message to the MN, the acknowledgement message comprising the first list of cell identifiers for the set of candidate cells,
wherein the cell group selective activation procedure comprises a subsequent conditional PSCell addition/change (CPAC) procedure.

17. The method of claim 16, further comprising preparing, for each of the set of candidate cells, a list of suggested subsequent candidate PSCells for a subsequent conditional cell change (CPC), wherein the acknowledgement message comprises, for each of the set of candidate cells, at least one of: a cell identifier, the list of suggested subsequent candidate PSCells or execution conditions for each of the suggested candidate PSCells.

18. The method of claim 16, wherein the request message comprises at least one of:
a list of suggested candidate SN or cell identifiers for a subsequent CPC;
a list of SN key to be used for the subsequent CPC; or
a list of counter values to be used for SN key derivation for the subsequent CPC.

19. The method of claim 17, further comprising receiving a report from the MN, the report informing the candidate SN a subset of the list of suggested subsequent candidate PSCells for the subsequent CPC, the subset of the list suggested subsequent candidate PSCells being included in a reconfiguration message sent from the MN to the wireless terminal.

20. A master node (MN) comprising at least one processor and a memory, wherein the at least one processor is configured to read code from the memory to:
send a request message to a candidate secondary node (SN) to request a preparation of a cell group selective activation procedure for a wireless terminal;
receive an acknowledgement message from the candidate SN in response to the request message, the acknowledgement message comprising a first list of cell identifiers for a set of candidate cells; and
send a reconfiguration message to the wireless terminal, the reconfiguration message comprising a cell group selective activation configuration,
wherein the cell group selective activation procedure comprises a subsequent conditional PSCell addition/change (CPAC) procedure, and wherein the cell group selective activation configuration comprises a subsequent CPAC configuration.

21. (canceled)
